(19) United States
(12) Patent Application Publication
(10) Pub. No.: US 2006/0168760 A1
(43) Pub. Date: Aug. 3, 2006

(54) Hinge arrangement for the front door of a cabinet

(76) Inventors: Estevao Marino Espindola, Joinville-Sc (BR); Ademar Testoni, Joinville-Sc (BR); Sthefan Verjas de Almeida, Sao Bernard Do Campo- Sp (BR); Jean Marcelo Ferreira, Joinville-Sc (BR)

Correspondence Address: DARBY & DARBY P.C., P. O. BOX 5257, NEW YORK, NY, 10150-5257, US

(21) Appl. No.: 10/536,678

(22) PCT Filed: Nov. 21, 2003
(86) PCT No.: PCT/BR03/00172

§ 371 Date: Feb. 3, 2006

(30) Foreign Application Priority Data
Nov. 25, 2002 (BR) PI0205141-9

(51) Int. Cl. E05D 11/06

(52) U.S. Cl. 16/374

(57) ABSTRACT

A hinge arrangement for the front door of a cabinet, comprising a hinge body (20) affixed to a lower front edge (11) of the cabinet (10) and carrying an upwardly projecting hinge pin (30), maintaining a certain spacing from the lower front edge (11) of the cabinet (10) and around which the front door is inferiorly journalled. A shoe (40) is inferiorly mounted to the hinge body (20) so as to be selectively manually displaced between an inoperative position, in which it is operatively spaced from the floor (P) that supports the cabinet (10), and an operative position, in which it is seated on the floor (P), in order to transfer to the latter the weight of the front door and to lock the cabinet (10) against displacements on the floor (P).

### FIELD OF THE INVENTION

The present invention refers to a lower hinge arrangement to sustain a front door of a cabinet, particularly a front door of a cabinet for refrigerators or freezers that is angularly displaced around a vertical axis between the closing and opening positions of the cabinet.

### PRIOR ART

The lower front doors of the cabinets for refrigerators or freezers are inferiorly articulated and supported by a hinge comprising a body that is adequately shaped and dimensioned to be secured, generally by screws, to the lower front edge of the cabinet, close to its side on which the vertical hinge axis of the door is disposed. The hinge body may carry an upper vertical hinge pin, around which the door is rotatably supported.

In these known constructions, the hinge body is affixed to the metallic front flange of the cabinet, projecting slightly forwardly so as to maintain the vertical hinge pin disposed on a plane that is parallel to and slightly spaced from the front flange of the cabinet, making the whole weight of the door and all the dynamic loads associated with its operational angular displacement to be applied to the front flange of the cabinet by the hinge body projecting in cantilever forwardly from the plane of said front flange.

In this usual mounting arrangement, the weight of the door, which generally supports several loads on its internal shelves, as well as its operational angular movement, produce deformations in the front structure of the cabinet and in the hinge body sufficient to misalign the door in relation to the correct seating position of the sealing gasket on its seat defined by the front flange of the cabinet.

The static and dynamic loads produced by the door are applied to the cabinet in a point of the latter that is forwardly displaced in relation to the cabinet itself and to its front feet seated on the floor. This fact weakens the door support system and leads to the type of misalignment mentioned above, requiring structural reinforcements to be made in the hinge body and in the structure of the cabinet so as to avoid excessive deformations and even ruptures in the fixation of the lower hinge to the front flange of the cabinet. The complete suppression of the disadvantages above requires complex constructions, which are economically unfeasible in most products.

Besides the inconveniences mentioned above, the known lower hinges have to be removed from one of the sides of the cabinet and remounted on the other side when it is necessary to revert the opening direction of the door. The reversion of the opening direction of the door requires operations of unscrewing and re-screwing the hinge body in relation to the front flange of the cabinet.

Another inconvenience of the known lower hinge arrangements results from the fact that the hinge body is secured to the cabinet by means of screws which are disposed according to only one traction direction, requiring great rigidity from the parts defined by the hinge and front flange to minimize the deformations provoked by application of the door loads onto the cabinet. The higher degree of rigidity of said parts is obtained with constructions that require stronger and more expensive stamped materials for the hinge body and a higher thickness for the front flange of the cabinet at least in its lower region. Stamping the hinges also has the disadvantage of allowing undesirable dimensional variations to occur in the finished piece.

### OBJECTS OF THE INVENTION

Due to the problems mentioned above and to other disadvantages or deficiencies associated with the known prior art solutions, to be discussed throughout the present specification, it is the generic object of the present invention to provide a lower hinge arrangement for the door of a cabinet, particularly the front door of a cabinet for refrigerators and freezers, which presents a simple and versatile construction, guaranteeing a strong support for the door without transmitting the static and dynamic loads from the latter to the cabinet during the operation thereof and allowing a rapid reversion of the opening direction of the door to be effected with no need of dismounting the hinge in relation to the cabinet.

It is a further object of the present invention to provide a hinge arrangement such as mentioned above, which can be firmly affixed to the cabinet without requiring the same degrees of structural rigidity for the parts defined by the hinge and the front flange of the cabinet which are required in the known prior art arrangements in order to provide the necessary strength in the assembly of the door.

It is a further object of the invention to provide a hinge arrangement as defined above, with a simple and relatively low cost construction and which can be affixed to the cabinet by screws disposed in mutually orthogonal directions.

It is still a further object of the invention to provide a hinge arrangement as defined above, which can incorporate a respective manually adjustable leveling foot.

### SUMMARY OF THE INVENTION

The present hinge arrangement is applied to a front door of a cabinet having a lower front edge.

According to the invention, the hinge arrangement comprises a hinge body affixed to the lower front edge of the cabinet and carrying an upwardly projecting hinge pin, maintaining a certain spacing from the lower front edge of the cabinet and around which the front door is inferiorly journalled.

The present arrangement further comprises a shoe that is inferiorly mounted to the hinge body according to a vertical axis, maintaining said certain spacing from the lower front edge of the cabinet. The shoe is selectively manually displaced towards said axis between an inoperative position, in which it is operatively spaced from the floor, and an operative position, in which it is seated on the floor, so as to transfer to the latter the weight of the front door and to lock the cabinet against displacements on the floor.

### BRIEF DESCRIPTION OF THE DRAWINGS

The invention will be described below, with reference to the enclosed drawings given as a way of example for a preferred embodiment, and in which:

FIG. 1 is a perspective view of the present hinge arrangement already affixed to the lower front edge of the cabinet;

FIG. 2 is an exploded perspective view of the hinge arrangement illustrated in FIG. 1;

FIG. 3 is a top plan view of the hinge arrangement illustrated in FIG. 1;

FIG. 4 is a vertical sectional view of the hinge arrangement, taken according to line IV-IV of FIG. 3; and

FIG. 5 is a vertical sectional view of the hinge arrangement affixed to the cabinet, taken according to line V-V of FIG. 3.

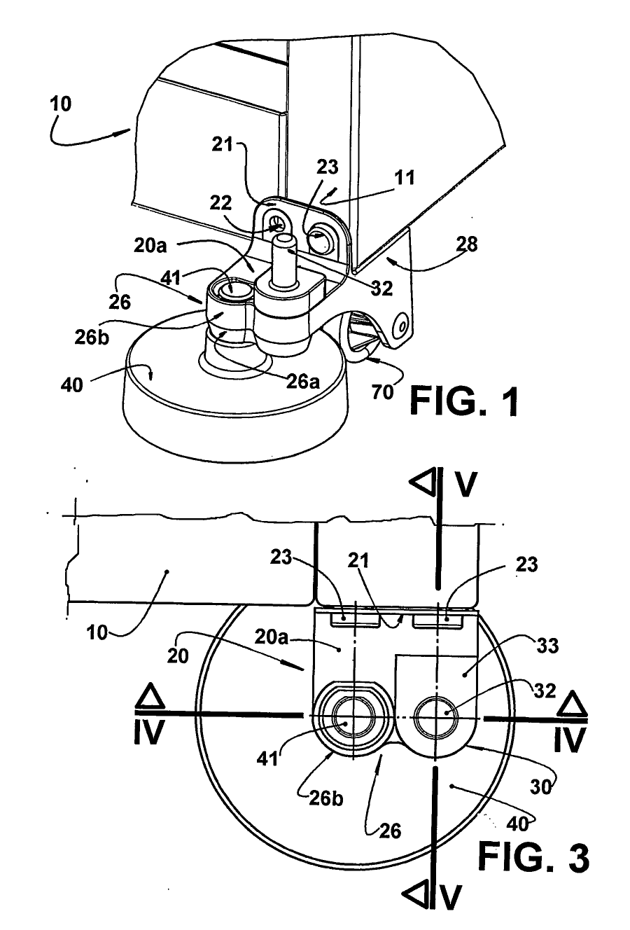

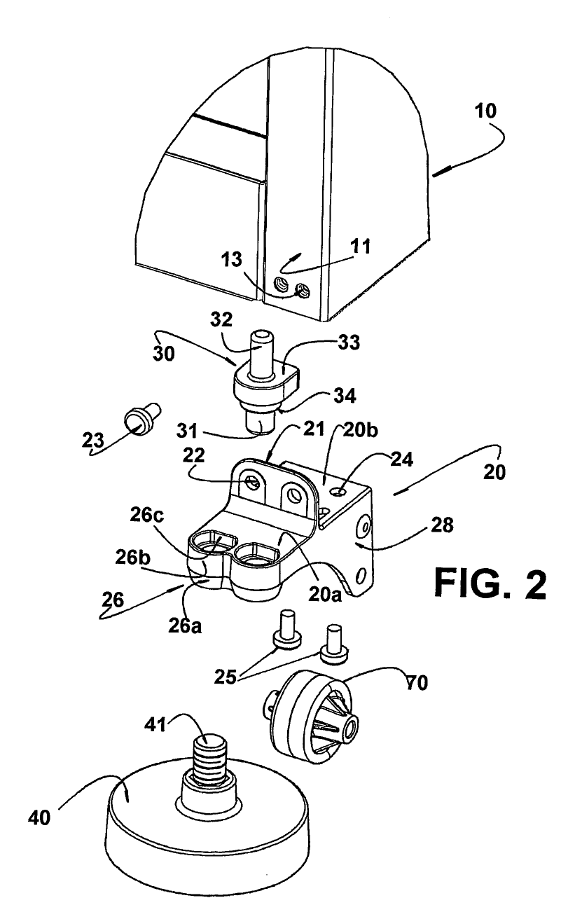

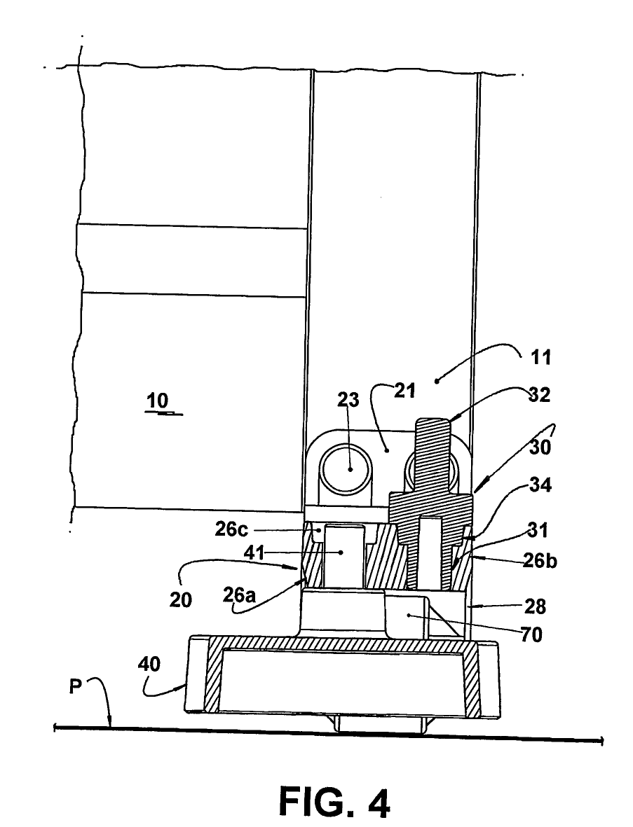

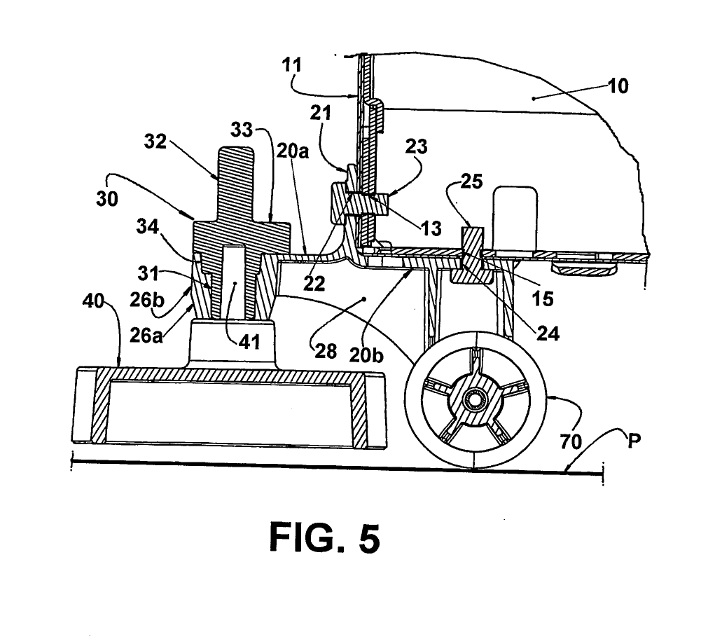

### DESCRIPTION OF THE ILLUSTRATED EMBODIMENT

As previously mentioned, the present hinge arrangement is designed to be applied to a cabinet 10 of a refrigerator, freezer, or other piece of furniture having a front door with a certain weight and which further produces relevant dynamic loads when angularly displaced around a vertical hinge axis between closing and opening positions. The hinge arrangement is designed to be seated and affixed, not only to a lower front edge 11 of the cabinet 10 but also under a lower wall portion 12 of the cabinet 10 disposed adjacent to the lower front edge 11 and forming with the latter a dihedral angle generally of 90 degrees, as described ahead.

According to the solution of the present invention, the hinge arrangement comprises a hinge body 20, which in the illustrated embodiment takes the form of a plate, with a substantially rectangular contour usually injected in Zamak and incorporating, orthogonally and medianly, an upper flange 21 extended along the width of the hinge body 20 and dividing the latter in a front portion 20a and a rear portion 20b, said upper flange 21 being provided with a pair of bores 22 for the passage of respective front screws 23, of which only one is illustrated.

With this construction, the hinge body 20 is mounted to the cabinet 10 on the hinge side of the front door, so as to have its upper flange 21 seated against the lower front edge 11 of the cabinet 10 and the upper face of the rear portion 20b of the hinge body 20, defined past the upper flange 21 and which is seated under the lower wall portion 12 of the cabinet 10. The rear portion 20b of the hinge body 20 is also provided with a pair of bores 24 for the passage of respective lower screws 25 to be threaded into bores 15 provided in the lower wall portion 12 of the cabinet 10. As illustrated, the front screws 23 are threaded into respective bores 13 provided on the lower front edge 11 of the cabinet 10.

Although the construction of the hinge body 20 mentioned above and illustrated in the drawing is not mandatory, it should be noted that the fixation effected by two groups of screws disposed according to mutually orthogonal directions allows achieving a greater rigidity upon mounting the hinge body 20, without requiring special reinforcements to be made in the lower structure of the cabinet 10, such as increasing the thickness or duplicating the metallic profiles used.

According to the illustrated construction, the front portion 20a of the hinge body 20 is provided with a pair of identical bores 26 which are disposed side by side, with their axes lying on a plane parallel to the lower front edge 11 of the cabinet 10. The two bores 26 present a lower portion 26a, which is threaded along at least part of its extension and having a smaller diameter, and an upper portion 26b, with a larger diameter and having a chamfer 26c so as to provide said upper portion 26b with a non-circular cross section.

In the bore 26 located closer to the adjacent lateral of the cabinet 10, there is removably fitted and retained, with a small gap, a lower portion 31 of a hinge pin 30 having an upper portion 32 projecting upwardly in relation to the hinge body 20, maintaining a certain spacing from the lower front edge 11 of the cabinet 10 and around which is inferiorly journalled the front door (not illustrated) of the cabinet 10.

In the illustrated embodiment, the hinge pin 30 incorporates a median flange 33 which is dimensioned to be seated onto the front portion 20a of the hinge body 20, in order to define a positioning stop means for the hinge pin 30 and an axial bearing onto which the front door seats and is angularly displaced.

The lower portion 31 of the hinge pin 30 further incorporates, superiorly and immediately below the median flange 33, an enlargement 34 with a cross-section which is similar to and slightly smaller than that of the upper portion 26b of the bore 26, allowing the chamfer 26c of the latter to produce the rotational locking of the hinge pin 30 inside the bore 26.

In the bore 26 located distant from the adjacent side of the cabinet 10, there is mounted a shoe pin 41 provided with an external thread and presenting and end to which is coaxially incorporated a shoe 40.

The shoe 40 has its shoe pin 41 threaded inside the lower portion 26a of a respective bore 26 of the body hinge 20, so as to be manually selectively rotated around its vertical axis, which coincides with that of the shoe pin 41, so as to be axially vertically displaced between an inoperative position, in which it is operatively spaced from the floor P that supports the cabinet, and an operative position, in which it is seated on the floor P, in order to transfer to the latter the weight of the front door and to lock the cabinet 10 against displacements on the floor P.

Although the bores 26 for the fixation of the hinge pin 30 and the shoe pin 41 can be coaxial, in the preferred and illustrated embodiment each hinge body is provided with two identical bores 26 disposed side by side, with their axes lying on a plane that is parallel to the lower front edge 11 of the cabinet 10.

The illustrated construction described above allows the cabinet 10 to be always provided with two hinge bodies 20 affixed to the lower front edge 11 of the cabinet 10 and also under the adjacent lower wall portion 12 of the latter, each hinge body 20 being disposed close to one of the sides of the cabinet 10. In this case, the hinge body 20, which is affixed close to the end of the lower front edge 11 turned to the opening side of the front door, receives a shoe 40, whereas the hinge body 20, which is disposed close to the side of the cabinet 10 adjacent to the hinge axis of the front door, receives, inferiorly, a shoe 40 and, superiorly, a hinge pin 30.

If it is necessary to revert the opening direction of the front door, the only thing to do is to remove the hinge pin 30 from one hinge body 20 and fit it into the respective bore 26 of the other hinge body 20.

In the illustrated construction, the hinge body 20 further carries, inferiorly, a roller 70 which allows the cabinet 10 to be displaced on the floor P when the shoes 40 are rotated around their axes and axially upwardly displaced, towards the inoperative position, in which they are operatively spaced from the floor P. Preferably, the roller 70 is journalled in a lower projection 28 of the rear portion 20b of the hinge body 20.

While only one embodiment of the invention has been illustrated, it should be understood that changes could be made in the form and arrangement, without departing from the constructive concept defined in the claims that accompany the present specification.

1. A hinge arrangement for the front door of a cabinet having a lower front edge, comprising a hinge body incorporating a front portion and a rear portion, affixed to the lower front edge of the cabinet and carrying an upwardly projecting hinge pin, maintaining a certain spacing from the lower front edge of the cabinet and around which the front door is inferiorly journalled; a shoe inferiorly mounted to the hinge body according to a vertical axis, maintaining said certain spacing from the lower front edge of the cabinet, said shoe being selectively manually displaced towards said axis between an inoperative position, in which it is operatively spaced from the floor that supports the cabinet, and an operative position, in which it is seated on the floor, in order to transfer to the latter the weight of the front door and to lock the cabinet against displacements on the floor.

2. The hinge arrangement as set forth in claim 1, wherein the hinge pin presents a lower portion, to be removably affixed into a corresponding bore provided in the hinge body, and an upper portion, projecting upwardly in relation to the latter.

3. The hinge arrangement as set forth in claim 2, wherein the hinge pin incorporates a median flange to be seated on the hinge body so as to define an axial bearing to support, inferiorly, the front door.

4. The hinge arrangement as set forth in claim 2, wherein the shoe is coupled to a shoe pin that is removably affixed into a corresponding bore provided in the hinge body.

5. The hinge arrangement as set forth in claim 4, wherein the hinge pin has its lower portion rotatably locked in the hinge body when fitted inside the respective bore of the latter.

6. The hinge arrangement as set forth in claim 5, wherein the bore of the hinge body presents a lower portion of smaller diameter, and an upper portion of larger diameter and with a non-circular cross section.

7. The hinge arrangement as set forth in claim 6, wherein the lower portion of the hinge pin incorporates an enlargement which is fitted and locked against rotation inside the upper portion of the bore of the hinge body, while the lower portion is fitted with a small gap inside the lower portion of the bore of the hinge body.

8. The hinge arrangement as set forth in claim 6, wherein the lower portion of the bore of the hinge body is threaded along at least part of its longitudinal extension.

9. The hinge arrangement as set forth in claim 8, wherein the shoe pin is provided with an external thread to be threaded inside the lower portion of a respective bore of the hinge body.

10. The hinge arrangement as set forth in claim 9, wherein the bores for the fixation of the hinge pin and the shoe pin are identical and disposed side by side, with their axes lying on a plane that is parallel to the lower front edge of the cabinet.

11. The hinge arrangement as set forth in claim 1, wherein the hinge body incorporates, medianly, an upper flange disposed between a front portion and a rear portion of the hinge body, said upper flange and rear portion being respectively seated and affixed against the lower front edge and under an adjacent lower wall portion of the cabinet.

12. The hinge arrangement as set forth in claim 11, wherein the upper flange and the rear portion of the hinge body are provided with bores for the passage of respective front screws and lower screws to be threaded into respective bores provided in the lower front edge and in the lower wall portion of the cabinet.

13. The hinge arrangement as set forth in claim 11, wherein the hinge body further carries, inferiorly, a roller for displacing the cabinet on the floor.

14. The hinge arrangement as set forth in claim 12, wherein the roller is journalled in a lower projection of the rear extension of the hinge body.

15. The hinge arrangement as set forth in claim 1, comprising two hinge bodies secured to the lower front edge of the cabinet, one of said hinge bodies carrying, inferiorly, a shoe and being affixed close to the end of the lower front edge turned to the opening side of the front door, and the other hinge body carrying, inferiorly, a shoe and, superiorly, a hinge pin and being affixed to the end of the lower front door turned to the hinge side of the front door.
